(19) United States
(12) Patent Application Publication
(10) Pub. No.: US 2026/0121925 A1
(43) Pub. Date: Apr. 30, 2026

(54) Network Flow Service

(71) Applicant: Oracle International Corporation, Redwood Shores, CA (US)

(72) Inventors: Jonathan Alan Knoll, Clayton, NC (US); Karl Heiss, Raleigh, NC (US); Robert Tomasko, Apex, NC (US)

(73) Assignee: Oracle International Corporation, Redwood Shores, CA (US)

(21) Appl. No.: 18/931,334

(22) Filed: Oct. 30, 2024

(51) Int. Cl. H04L 9/40

(52) U.S. Cl. CPC H04L 41/085; H04L 41/0823

(57) ABSTRACT

A system manages network connectivity in cloud environments. The system receives a high-level connectivity description comprising entities and flows representing connections between entities. Based on the description, the system derives a network configuration and applies it to configure resources in a cloud network environment. The system detects modifications, additions, or removals of resources in the cloud environment. In response to detected changes, the system modifies the network configuration to maintain consistency with the high-level description while accounting for resource alterations. The system generates a modified network configuration and applies it to at least one resource in the cloud environment.

### TECHNICAL FIELD

The present disclosure relates to the configuration of cloud networks.

### BACKGROUND

Cloud networks involve many elements, including various resources such as gateways, databases, and nodes with associated subnets, security lists, and routing tables. Configuring these elements correctly and ensuring they work together seamlessly is complex, especially in large-scale deployments. Current solutions require extensive networking expertise from application teams and manual coordination between teams to configure network connections, leading to deployment friction and security review bottlenecks.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIGS. 1-4 illustrate patterns for implementing a cloud infrastructure as a service system in accordance with one or more embodiments;

FIG. 5 illustrates a hardware system in accordance with one or more embodiments;

FIG. 6 illustrates a system for configuring a cloud network in accordance with one or more embodiments;

FIG. 7 illustrates an example set of operations for configuring a cloud network in accordance with one or more embodiments; and

FIG. 8 illustrates an example cloud network arrangement in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. CLOUD COMPUTING TECHNOLOGY
3. COMPUTER SYSTEM
4. CLOUD NETWORK CONFIGURATION SYSTEM
5. CLOUD NETWORK CONFIGURATION METHOD
6. CLOUD NETWORK EXAMPLE
7. PRACTICAL APPLICATIONS, ADVANTAGES & IMPROVEMENTS
8. MISCELLANEOUS; EXTENSIONS

### 1. General Overview

One or more embodiments receive a high-level connectivity description for managing network configurations in cloud environments. The system accepts user-defined entities and flows representing desired connections between resources. By abstracting complex networking details, users specify connectivity requirements without requiring deep technical knowledge. The high-level description serves as a blueprint for the system to derive and implement concrete network configurations.

One or more embodiments derive network configurations based on the high-level connectivity description. The system analyzes the specified entities and flows to generate appropriate security rules, and routing tables. During derivation, the system considers existing network topologies, available resources, and cloud provider constraints. The derived configuration translates abstract connectivity intentions into network parameters.

One or more embodiments apply derived network configurations to cloud resources. The system configures multiple resources corresponding to the entities defined in the high-level description. Configuration tasks include updating security group rules and modifying route tables. By automating the application process, the system reduces manual configuration errors and ensures consistency across the environment.

One or more embodiments responds to changes in cloud network resources. The system modifies network configurations in response to modifications, additions, or removals of resources. The system reevaluates the high-level connectivity description against the altered resource state. Configuration updates maintain consistency with user-defined intentions while accommodating resource changes. The modification process generates revised security rules, routing entries, and gateway configurations as needed. The system applies the modified network configurations to affected resources. The system identifies resources impacted by detected changes and updates their network settings.

One or more embodiments authorize network configuration actions using policy-based access control, implementing a permission model that accommodates various administrative roles and their intersecting responsibilities. The system evaluates user permissions before allowing modifications to network settings, ensuring that actions align with designated roles and security policies. The system validates high-level connectivity descriptions against these role-based policies before processing them, rejecting or flagging descriptions that violate established guidelines.

One or more embodiments described in this Specification and/or recited in the claims may not be included in this General Overview section.

### 2. Cloud Computing Technology

Infrastructure as a Service (IaaS) is an application of cloud computing technology. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In some cases, a cloud computing model will involve the participation of a cloud provider. The cloud provider may, but need not, be a third-party service that specializes in providing (e.g., offering, renting, selling) IaaS. An entity may also opt to deploy a private cloud, becoming its own provider of infrastructure services.

In some examples, IaaS deployment is the process of implementing a new application, or a new version of an application, onto a prepared application server or other similar device. IaaS deployment may also include the process of preparing the server (e.g., installing libraries, daemons, etc.). The deployment process is often managed by the cloud provider below the hypervisor layer (e.g., the servers, storage, network hardware, and virtualization). Thus, the customer may be responsible for handling Operating System (OS), middleware, and/or application deployment e.g., on self-service virtual machines that can be spun up on demand.

In some examples, IaaS provisioning may refer to acquiring computers or virtual hosts for use and even installing needed libraries or services on them. In most cases, deployment does not include provisioning, and the provisioning may need to be performed first.

In some cases, there are challenges for IaaS provisioning. There is an initial challenge of provisioning the initial set of infrastructure. There is an additional challenge of evolving the existing infrastructure (e.g., adding new services, changing services, removing services, etc.) after the initial provisioning is completed. In some cases, these challenges may be addressed by enabling the configuration of the infrastructure to be defined declaratively. In other words, the infrastructure (e.g., what components are needed and how they interact) can be defined by one or more configuration files. Thus, the overall topology of the infrastructure is described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up. Other infrastructure elements may also be provisioned, such as a load balancer, a database, or similar. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). In some embodiments, infrastructure and resources may be provisioned (manually and/or using a provisioning tool) prior to deployment of code to be executed on the infrastructure. In some instances, the provisioning can be done manually, a provisioning tool may be utilized to provision the resources, and/or deployment tools may be utilized to deploy the code once the infrastructure is provisioned.

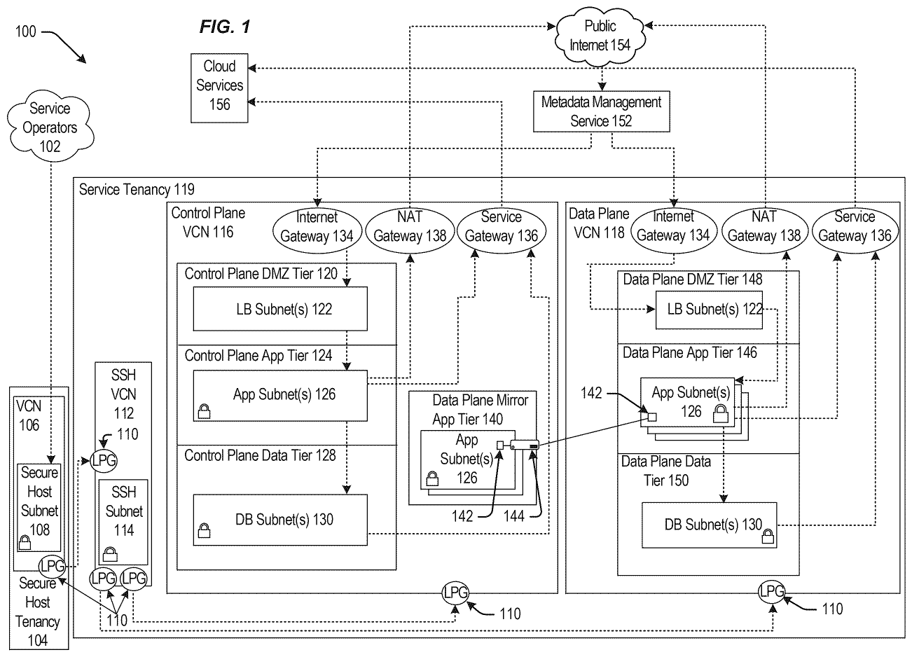

FIG. 1 is a block diagram illustrating an example pattern of an IaaS architecture 100 according to at least one embodiment. Service operators 102 can be communicatively coupled to a secure host tenancy 104 that can include a virtual cloud network (VCN) 106 and a secure host subnet 108. In some examples, the service operators 102 may be using one or more client computing devices that may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers executing any of a variety of commercially-available UNIX® or UNIX-like operating systems, including without limitation the variety of GNU/Linux operating systems, such as for example, Google Chrome OS. Additionally, or alternatively, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 106 and/or the Internet.

The VCN 106 can include a local peering gateway (LPG) 110 that can be communicatively coupled to a secure shell (SSH) VCN 112 via an LPG 110 contained in the SSH VCN 112. The SSH VCN 112 can include an SSH subnet 114, and the SSH VCN 112 can be communicatively coupled to a control plane VCN 116 via the LPG 110 contained in the control plane VCN 116. Also, the SSH VCN 112 can be communicatively coupled to a data plane VCN 118 via an LPG 110. The control plane VCN 116 and the data plane VCN 118 can be contained in a service tenancy 119 that can be owned and/or operated by the IaaS provider.

The control plane VCN 116 can include a control plane demilitarized zone (DMZ) tier 120 that acts as a perimeter network (e.g., portions of a corporate network between the corporate intranet and external networks). The DMZ-based servers may have restricted responsibilities and help keep breaches contained. Additionally, the DMZ tier 120 can include one or more load balancer (LB) subnet(s) 122, a control plane app tier 124 that can include app subnet(s) 126, a control plane data tier 128 that can include database (DB) subnet(s) 130 (e.g., frontend DB subnet(s) and/or backend DB subnet(s)). The LB subnet(s) 122 contained in the control plane DMZ tier 120 can be communicatively coupled to the app subnet(s) 126 contained in the control plane app tier 124. The LB subnet(s) 122 may further be communicatively coupled to an Internet gateway 134 that can be contained in the control plane VCN 116. The app subnet(s) 126 can be communicatively coupled to the DB subnet(s) 130 contained in the control plane data tier 128, a service gateway 136 and a network address translation (NAT) gateway 138. The control plane VCN 116 can include the service gateway 136 and the NAT gateway 138.

The control plane VCN 116 can include a data plane mirror app tier 140 that can include app subnet(s) 126. The app subnet(s) 126 contained in the data plane mirror app tier 140 can include a virtual network interface controller (VNIC) 142 that can execute a compute instance 144. The compute instance 144 can communicatively couple the app subnet(s) 126 of the data plane mirror app tier 140 to app subnet(s) 126 that can be contained in a data plane app tier 146.

The data plane VCN 118 can include the data plane app tier 146, a data plane DMZ tier 148, and a data plane data tier 150. The data plane DMZ tier 148 can include LB subnet(s) 122 that can be communicatively coupled to the app subnet(s) 126 of the data plane app tier 146 and the Internet gateway 134 of the data plane VCN 118. The app subnet(s) 126 can be communicatively coupled to the service gateway 136 of the data plane VCN 118 and the NAT gateway 138 of the data plane VCN 118. The data plane data tier 150 can also include the DB subnet(s) 130 that can be communicatively coupled to the app subnet(s) 126 of the data plane app tier 146.

The Internet gateway 134 of the control plane VCN 116 and of the data plane VCN 118 can be communicatively coupled to a metadata management service 152 that can be communicatively coupled to public Internet 154. Public Internet 154 can be communicatively coupled to the NAT gateway 138 of the control plane VCN 116 and of the data plane VCN 118. The service gateway 136 of the control plane VCN 116 and of the data plane VCN 118 can be communicatively couple to cloud services 156.

In some examples, the service gateway 136 of the control plane VCN 116 or of the data plane VCN 118 can make application programming interface (API) calls to cloud services 156 without going through public Internet 154. The service gateway 136 can make API calls to cloud services 156, and cloud services 156 can send requested data to the service gateway 136.

In some examples, the secure host tenancy 104 can be directly connected to the service tenancy 119 that may be otherwise isolated. The secure host subnet 108 can communicate with the SSH subnet 114 through an LPG 110 that may enable two-way communication over an otherwise isolated system. Connecting the secure host subnet 108 to the SSH subnet 114 may give the secure host subnet 108 access to other entities within the service tenancy 119.

The control plane VCN 116 may allow users of the service tenancy 119 to set up or otherwise provision desired resources. Desired resources provisioned in the control plane VCN 116 may be deployed or otherwise used in the data plane VCN 118. In some examples, the control plane VCN 116 can be isolated from the data plane VCN 118. The data plane mirror app tier 140 of the control plane VCN 116 can communicate with the data plane app tier 146 of the data plane VCN 118 via VNICs 142. VNICs 142 can be contained in the data plane mirror app tier 140 and the data plane app tier 146.

In some examples, users of the system, or customers, can make requests, for example create, read, update, or delete (CRUD) operations, through public Internet 154 that can communicate the requests to the metadata management service 152. The metadata management service 152 can communicate the request to the control plane VCN 116 through the Internet gateway 134. The request can be received by the LB subnet(s) 122 contained in the control plane DMZ tier 120. The LB subnet(s) 122 may determine that the request is valid, and in response to this determination, the LB subnet(s) 122 can transmit the request to app subnet(s) 126 contained in the control plane app tier 124. If the request is validated and requires a call to public Internet 154, the call to public Internet 154 may be transmitted to the NAT gateway 138 that can make the call to public Internet 154. Metadata that may be desired to be stored by the request can be stored in the DB subnet(s) 130.

In some examples, the data plane mirror app tier 140 can facilitate direct communication between the control plane VCN 116 and the data plane VCN 118. For example, changes, updates, or other suitable modifications to configuration may be desired to be applied to the resources contained in the data plane VCN 118. Via a VNIC 142, the control plane VCN 116 can directly communicate with, and can thereby execute the changes, updates, or other suitable modifications to configurations of resources contained in the data plane VCN 118.

In some embodiments, the control plane VCN 116 and the data plane VCN 118 can be contained in the service tenancy 119. The user, or the customer, of the system may be restricted from owning or operating either the control plane VCN 116 or the data plane VCN 118. Instead, the IaaS provider may own or operate the control plane VCN 116 and the data plane VCN 118; both may be contained in the service tenancy 119. This embodiment can enable isolation of networks that may prevent users or customers from interacting with other users' or other customers' resources. Also, this embodiment may allow users or customers of the system to store databases privately without needing to rely on public Internet 154 that may not have a desired level of threat prevention for storage.

In other embodiments, the LB subnet(s) 122 contained in the control plane VCN 116 can be configured to receive a signal from the service gateway 136. In this embodiment, the control plane VCN 116 and the data plane VCN 118 may be configured to be called by a customer of the IaaS provider without calling public Internet 154. Customers of the IaaS provider may desire this embodiment since database(s) that the customers use may be controlled by the IaaS provider and may be stored on the service tenancy 119 that may be isolated from public Internet 154.

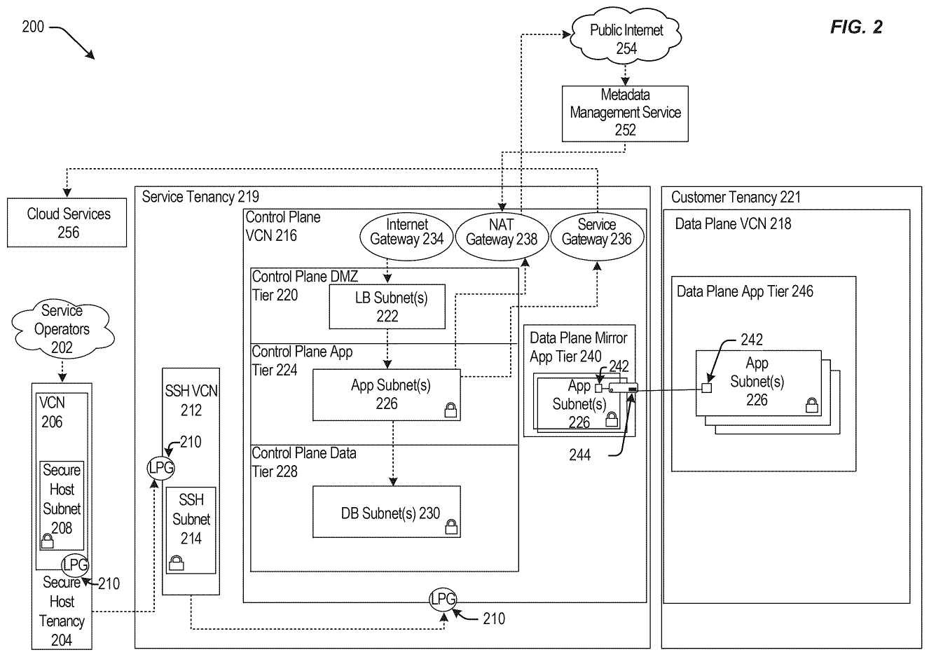

FIG. 2 is a block diagram illustrating another example pattern of an IaaS architecture 200, according to at least one embodiment. Service operators 202 (e.g., service operators 102 of FIG. 1) can be communicatively coupled to a secure host tenancy 204 (e.g., the secure host tenancy 104 of FIG. 1) that can include a virtual cloud network (VCN) 206 (e.g., the VCN 106 of FIG. 1) and a secure host subnet 208 (e.g., the secure host subnet 108 of FIG. 1). The VCN 206 can include a local pecring gateway (LPG) 210 (e.g., the LPG 110 of FIG. 1) that can be communicatively coupled to a secure shell (SSH) VCN 212 (e.g., the SSH VCN 112 of FIG. 1) via an LPG 110 contained in the SSH VCN 212. The SSH VCN 212 can include an SSH subnet 214 (e.g., the SSH subnet 114 of FIG. 1), and the SSH VCN 212 can be communicatively coupled to a control plane VCN 216 (e.g., the control plane VCN 116 of FIG. 1) via an LPG 210 contained in the control plane VCN 216. The control plane VCN 216 can be contained in a service tenancy 219 (e.g., the service tenancy 119 of FIG. 1), and the data plane VCN 218 (e.g., the data plane VCN 118 of FIG. 1) can be contained in a customer tenancy 221 that may be owned or operated by users, or customers, of the system.

The control plane VCN 216 can include a control plane DMZ tier 220 (e.g., the control plane DMZ tier 120 of FIG. 1) that can include LB subnet(s) 222 (e.g., LB subnet(s) 122 of FIG. 1), a control plane app tier 224 (e.g., the control plane app tier 124 of FIG. 1) that can include app subnet(s) 226 (e.g., app subnet(s) 126 of FIG. 1), and a control plane data tier 228 (e.g., the control plane data tier 128 of FIG. 1) that can include database (DB) subnet(s) 230 (e.g., similar to DB subnet(s) 130 of FIG. 1). The LB subnet(s) 222 contained in the control plane DMZ tier 220 can be communicatively coupled to the app subnet(s) 226 contained in the control plane app tier 224 and an Internet gateway 234 (e.g., the Internet gateway 134 of FIG. 1). The Internet gateway 234 can be contained in the control plane VCN 216. Additionally, the app subnet(s) 226 can be communicatively coupled to the DB subnet(s) 230 contained in the control plane data tier 228, a service gateway 236 (e.g., the service gateway 136 of FIG. 1) and a network address translation (NAT) gateway 238 (e.g., the NAT gateway 138 of FIG. 1). The control plane VCN 216 can include the service gateway 236 and the NAT gateway 238.

The control plane VCN 216 can include a data plane mirror app tier 240 (e.g., the data plane mirror app tier 140 of FIG. 1) that can include app subnet(s) 226. The app subnet(s) 226 contained in the data plane mirror app tier 240 can include a virtual network interface controller (VNIC) 242 (e.g., the VNIC of 142) that can execute a compute instance 244 (e.g., similar to the compute instance 144 of FIG. 1). The compute instance 244 can facilitate communication between the app subnet(s) 226 of the data plane mirror app tier 240 and the app subnet(s) 226 that can be contained in a data plane app tier 246 (e.g., the data plane app tier 146 of FIG. 1) via the VNIC 242 contained in the data plane mirror app tier 240 and the VNIC 242 contained in the data plane app tier 246.

The Internet gateway 234 contained in the control plane VCN 216 can be communicatively coupled to a metadata management service 252 (e.g., the metadata management service 152 of FIG. 1) that can be communicatively coupled to public Internet 254 (e.g., public Internet 154 of FIG. 1). Public Internet 254 can be communicatively coupled to the NAT gateway 238 contained in the control plane VCN 216. The service gateway 236 contained in the control plane VCN 216 can be communicatively couple to cloud services 256 (e.g., cloud services 156 of FIG. 1).

In some examples, the data plane VCN 218 can be contained in the customer tenancy 221. In this case, the IaaS provider may provide the control plane VCN 216 for customers, and the IaaS provider may, for each customer, set up a unique, compute instance 244 that is contained in the service tenancy 219. Compute instance 244 may allow communication between the control plane VCN 216, contained in the service tenancy 219, and the data plane VCN 218, contained in the customer tenancy 221. The compute instance 244 may allow resources provisioned in the control plane VCN 216 that is contained in the service tenancy 219 to be deployed or otherwise used in the data plane VCN 218 that is contained in the customer tenancy 221.

In other examples, the customer of the IaaS provider may have databases that live in the customer tenancy 221. In this example, the control plane VCN 216 can include the data plane mirror app tier 240 that can include app subnet(s) 226. The data plane mirror app tier 240 can reside in the data plane VCN 218, but the data plane mirror app tier 240 may not live in the data plane VCN 218. That is, the data plane mirror app tier 240 may have access to the customer tenancy 221, but the data plane mirror app tier 240 may not exist in the data plane VCN 218 or be owned or operated by the customer of the IaaS provider. The data plane mirror app tier 240 may be configured to make calls to the data plane VCN 218 but may not be configured to make calls to any entity contained in the control plane VCN 216. The customer may desire to deploy or otherwise use resources in the data plane VCN 218 that are provisioned in the control plane VCN 216, and the data plane mirror app tier 240 can facilitate the desired deployment, or other usage of resources, of the customer.

In some embodiments, the customer of the IaaS provider can apply filters to the data plane VCN 218. In this embodiment, the customer can determine what the data plane VCN 218 can access, and the customer may restrict access to public Internet 254 from the data plane VCN 218. The IaaS provider may not be able to apply filters or otherwise control access of the data plane VCN 218 to any outside networks or databases. Applying filters and controls by the customer onto the data plane VCN 218, contained in the customer tenancy 221, can help isolate the data plane VCN 218 from other customers and from public Internet 254.

In some embodiments, cloud services 256 can be called by the service gateway 236 to access services that may not exist on public Internet 254, on the control plane VCN 216, or on the data plane VCN 218. The connection between cloud services 256 and the control plane VCN 216 or the data plane VCN 218 may not be live or continuous. Cloud services 256 may exist on a different network owned or operated by the IaaS provider. Cloud services 256 may be configured to receive calls from the service gateway 236 and may be configured to not receive calls from public Internet 254. Some cloud services 256 may be isolated from other cloud services 256, and the control plane VCN 216 may be isolated from cloud services 256 that may not be in the same region as the control plane VCN 216. For example, the control plane VCN 216 may be located in Region 1, and cloud service Deployment 1 may be located in Region 1 and in Region 2. If a call to Deployment 1 is made by the service gateway 236 contained in the control plane VCN 216 located in Region 1, the call may be transmitted to Deployment 1 in Region 1. In this example, the control plane VCN 216, or Deployment 1 in Region 1, may not be communicatively coupled to, or otherwise in communication with, Deployment 1 in Region 2.

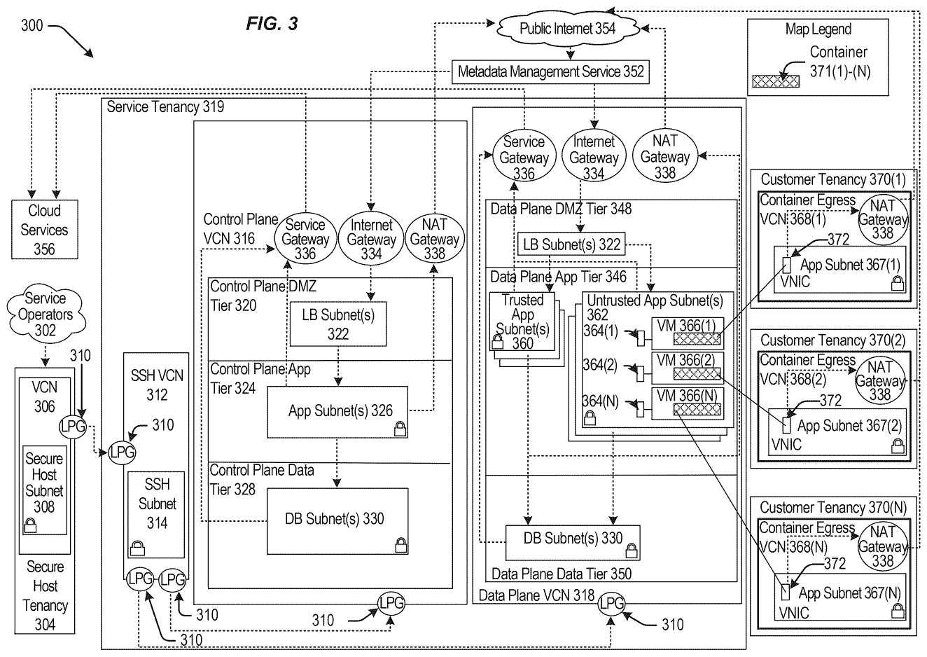

FIG. 3 is a block diagram illustrating another example pattern of an IaaS architecture 300 according to at least one embodiment. Service operators 302 (e.g., service operators 102 of FIG. 1) can be communicatively coupled to a secure host tenancy 304 (e.g., the secure host tenancy 104 of FIG. 1) that can include a virtual cloud network (VCN) 306 (e.g., the VCN 106 of FIG. 1) and a secure host subnet 308 (e.g., the secure host subnet 108 of FIG. 1). The VCN 306 can include an LPG 310 (e.g., the LPG 110 of FIG. 1) that can be communicatively coupled to an SSH VCN 312 (e.g., the SSH VCN 112 of FIG. 1) via an LPG 310 contained in the SSH VCN 312. The SSH VCN 312 can include an SSH subnet 314 (e.g., the SSH subnet 114 of FIG. 1), and the SSH VCN 312 can be communicatively coupled to a control plane VCN 316 (e.g., the control plane VCN 116 of FIG. 1) via an LPG 310 contained in the control plane VCN 316 and to a data plane VCN 318 (e.g., the data plane VCN 118 of FIG. 1) via an LPG 310 contained in the data plane VCN 318. The control plane VCN 316 and the data plane VCN 318 can be contained in a service tenancy 319 (e.g., the service tenancy 119 of FIG. 1).

The control plane VCN 316 can include a control plane DMZ tier 320 (e.g., the control plane DMZ tier 120 of FIG. 1) that can include load balancer (LB) subnet(s) 322 (e.g., LB subnet(s) 122 of FIG. 1), a control plane app tier 324 (e.g., the control plane app tier 124 of FIG. 1) that can include app subnet(s) 326 (e.g., similar to app subnet(s) 126 of FIG. 1), and a control plane data tier 328 (e.g., the control plane data tier 128 of FIG. 1) that can include DB subnet(s) 330. The LB subnet(s) 322 contained in the control plane DMZ tier 320 can be communicatively coupled to the app subnet(s) 326 contained in the control plane app tier 324 and to an Internet gateway 334 (e.g., the Internet gateway 134 of FIG. 1) that can be contained in the control plane VCN 316. Additionally, the app subnet(s) 326 can be communicatively coupled to the DB subnet(s) 330 contained in the control plane data tier 328, to a service gateway 336 (e.g., the service gateway of FIG. 1), and a network address translation (NAT) gateway 338 (e.g., the NAT gateway 138 of FIG. 1). The control plane VCN 316 can include the service gateway 336 and the NAT gateway 338.

The data plane VCN 318 can include a data plane app tier 346 (e.g., the data plane app tier 146 of FIG. 1), a data plane DMZ tier 348 (e.g., the data plane DMZ tier 148 of FIG. 1), and a data plane data tier 350 (e.g., the data plane data tier 150 of FIG. 1). The data plane DMZ tier 348 can include LB subnet(s) 322 that can be communicatively coupled to trusted app subnet(s) 360 and untrusted app subnet(s) 362 of the data plane app tier 346 and the Internet gateway 334 contained in the data plane VCN 318. The trusted app subnet(s) 360 can be communicatively coupled to the service gateway 336 contained in the data plane VCN 318, the NAT gateway 338 contained in the data plane VCN 318, and DB subnet(s) 330 contained in the data plane data tier 350. The untrusted app subnet(s) 362 can be communicatively coupled to the service gateway 336 contained in the data plane VCN 318 and DB subnet(s) 330 contained in the data plane data tier 350. The data plane data tier 350 can include DB subnet(s) 330 that can be communicatively coupled to the service gateway 336 contained in the data plane VCN 318.

The untrusted app subnet(s) 362 can include one or more primary VNICs 364(1)-(N) that can be communicatively coupled to tenant virtual machines (VMs) 366(1)-(N). Each tenant VM 366(1)-(N) can be communicatively coupled to a respective app subnet 367(1)-(N) that can be contained in respective container egress VCNs 368(1)-(N) that can be contained in respective customer tenancies 380(1)-(N). Respective secondary VNICs 372(1)-(N) can facilitate communication between the untrusted app subnet(s) 362 contained in the data plane VCN 318 and the app subnet contained in the container egress VCNs 368(1)-(N). Each container egress VCNs 368(1)-(N) can include a NAT gateway 338 that can be communicatively coupled to public Internet 354 (e.g., public Internet 154 of FIG. 1).

The Internet gateway 334 contained in the control plane VCN 316 and contained in the data plane VCN 318 can be communicatively coupled to a metadata management service 352 (e.g., the metadata management service 152 of FIG. 1) that can be communicatively coupled to public Internet 354. Public Internet 354 can be communicatively coupled to the NAT gateway 338 contained in the control plane VCN 316 and contained in the data plane VCN 318. The service gateway 336 contained in the control plane VCN 316 and contained in the data plane VCN 318 can be communicatively couple to cloud services 356.

In some embodiments, the data plane VCN 318 can be integrated with customer tenancies 380. This integration can be useful or desirable for customers of the IaaS provider in some cases such as a case that may desire support when executing code. The customer may provide code to execute that may be destructive, may communicate with other customer resources, or may otherwise cause undesirable effects. In response to this, the IaaS provider may determine whether or not to execute code given to the IaaS provider by the customer.

In some examples, the customer of the IaaS provider may grant temporary network access to the IaaS provider and request a function to be attached to the data plane app tier 346. Code to execute the function may be executed in the VMs 366(1)-(N), and the code may not be configured to execute anywhere else on the data plane VCN 318. Each VM 366(1)-(N) may be connected to one customer tenancy 380. Respective containers 381(1)-(N) contained in the VMs 366(1)-(N) may be configured to execute the code. In this case, there can be a dual isolation, e.g., the containers 381(1)-(N) execute code, where the containers 381(1)-(N) may be contained in at least the VM 366(1)-(N) that are contained in the untrusted app subnet(s) 362). This may help prevent incorrect or otherwise undesirable code from damaging the network of the IaaS provider or from damaging a network of a different customer. The containers 381(1)-(N) may be communicatively coupled to the customer tenancy 380 and may be configured to transmit or receive data from the customer tenancy 380. The containers 381(1)-(N) may not be configured to transmit or receive data from any other entity in the data plane VCN 318. Upon completion of executing the code, the IaaS provider may kill or otherwise dispose of the containers 381(1)-(N).

In some embodiments, the trusted app subnet(s) 360 may execute code that may be owned or operated by the IaaS provider. In this embodiment, the trusted app subnet(s) 360 may be communicatively coupled to the DB subnet(s) 330 and be configured to execute CRUD operations in the DB subnet(s) 330. The untrusted app subnet(s) 362 may be communicatively coupled to the DB subnet(s) 330, but in this embodiment, the untrusted app subnet(s) may be configured to execute read operations in the DB subnet(s) 330. The containers 381(1)-(N) that can be contained in the VM 366(1)-(N) of each customer and that may execute code from the customer may not be communicatively coupled with the DB subnet(s) 330.

In other embodiments, the control plane VCN 316 and the data plane VCN 318 may not be directly communicatively coupled. In this embodiment, there may be no direct communication between the control plane VCN 316 and the data plane VCN 318. However, communication can occur indirectly through at least one method. An LPG 310 may be established by the IaaS provider that can facilitate communication between the control plane VCN 316 and the data plane VCN 318. In another example, the control plane VCN 316 or the data plane VCN 318 can make a call to cloud services 356 via the service gateway 336. For example, a call to cloud services 356 from the control plane VCN 316 can include a request for a service that can communicate with the data plane VCN 318.

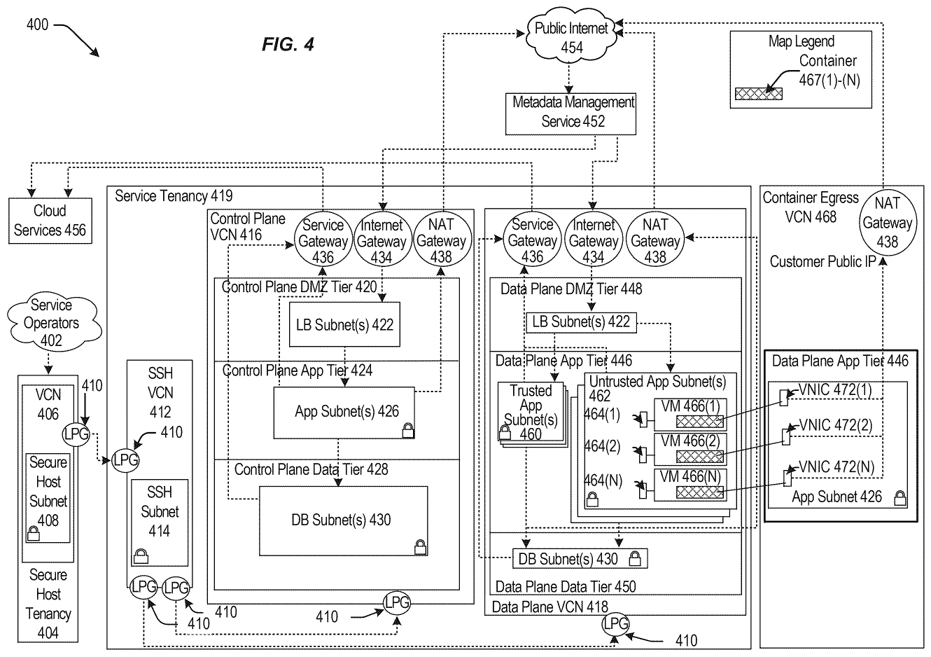

FIG. 4 is a block diagram illustrating another example pattern of an IaaS architecture 400 according to at least one embodiment. Service operators 402 (e.g., service operators 102 of FIG. 1) can be communicatively coupled to a secure host tenancy 404 (e.g., the secure host tenancy 104 of FIG. 1) that can include a virtual cloud network (VCN) 406 (e.g., the VCN 106 of FIG. 1) and a secure host subnet 408 (e.g., the secure host subnet 108 of FIG. 1). The VCN 406 can include an LPG 410 (e.g., the LPG 110 of FIG. 1) that can be communicatively coupled to an SSH VCN 412 (e.g., the SSH VCN 112 of FIG. 1) via an LPG 410 contained in the SSH VCN 412. The SSH VCN 412 can include an SSH subnet 414 (e.g., the SSH subnet 114 of FIG. 1). The SSH VCN 412 can be communicatively coupled to a control plane VCN 416 (e.g., the control plane VCN 116 of FIG. 1) via an LPG 410 contained in the control plane VCN 416. The SSH VCN 412 can be communicatively coupled to a data plane VCN 418 (e.g., the data plane VCN 118 of FIG. 1) via an LPG 410 contained in the data plane VCN 418. The control plane VCN 416 and the data plane VCN 418 can be contained in a service tenancy 419 (e.g., the service tenancy 119 of FIG. 1).

The control plane VCN 416 can include a control plane DMZ tier 420 (e.g., the control plane DMZ tier 120 of FIG. 1) that can include LB subnet(s) 422 (e.g., LB subnet(s) 122 of FIG. 1), a control plane app tier 424 (e.g., the control plane app tier 124 of FIG. 1) that can include app subnet(s) 426 (e.g., app subnet(s) 126 of FIG. 1), and a control plane data tier 428 (e.g., the control plane data tier 128 of FIG. 1) that can include DB subnet(s) 430 (e.g., DB subnet(s) 330 of FIG. 3). The LB subnet(s) 422 contained in the control plane DMZ tier 420 can be communicatively coupled to the app subnet(s) 426 contained in the control plane app tier 424. The LB subnet(s) 422 can be communicatively coupled to an Internet gateway 434 (e.g., the Internet gateway 134 of FIG. 1) that can be contained in the control plane VCN 416. The app subnet(s) 426 can be communicatively coupled to the DB subnet(s) 430 contained in the control plane data tier 428, a service gateway 436 (e.g., the service gateway of FIG. 1), and a network address translation (NAT) gateway 438 (e.g., the NAT gateway 138 of FIG. 1). The control plane VCN 416 can include the service gateway 436 and the NAT gateway 438.

The data plane VCN 418 can include a data plane app tier 446 (e.g., the data plane app tier 146 of FIG. 1), a data plane DMZ tier 448 (e.g., the data plane DMZ tier 148 of FIG. 1), and a data plane data tier 450 (e.g., the data plane data tier 150 of FIG. 1). The data plane DMZ tier 448 can include LB subnet(s) 422 that can be communicatively coupled to trusted app subnet(s) 460 (e.g., trusted app subnet(s) 360 of FIG. 3) and untrusted app subnet(s) 462 (e.g., untrusted app subnet(s) 362 of FIG. 3) of the data plane app tier 446 and the Internet gateway 434 contained in the data plane VCN 418. The trusted app subnet(s) 460 can be communicatively coupled to the service gateway 436 contained in the data plane VCN 418, the NAT gateway 438 contained in the data plane VCN 418, and DB subnet(s) 430 contained in the data plane data tier 450. The untrusted app subnet(s) 462 can be communicatively coupled to the service gateway 436 contained in the data plane VCN 418 and DB subnet(s) 430 contained in the data plane data tier 450. The data plane data tier 450 can include DB subnet(s) 430 that can be communicatively coupled to the service gateway 436 contained in the data plane VCN 418.

The untrusted app subnet(s) 462 can include primary VNICs 464(1)-(N) that can be communicatively coupled to tenant virtual machines (VMs) 466(1)-(N) residing within the untrusted app subnet(s) 462. Each tenant VM 466(1)-(N) can execute code in a respective container 467(1)-(N) and be communicatively coupled to an app subnet 426 that can be contained in a data plane app tier 446 that can be contained in a container egress VCN 468. Respective secondary VNICs 472(1)-(N) can facilitate communication between the untrusted app subnet(s) 462 contained in the data plane VCN 418 and the app subnet contained in the container egress VCN 468. The container egress VCN can include a NAT gateway 438 that can be communicatively coupled to public Internet 454 (e.g., public Internet 154 of FIG. 1).

The Internet gateway 434 contained in the control plane VCN 416 and contained in the data plane VCN 418 can be communicatively coupled to a metadata management service 452 (e.g., the metadata management service 152 of FIG. 1) that can be communicatively coupled to public Internet 454. Public Internet 454 can be communicatively coupled to the NAT gateway 438 contained in the control plane VCN 416 and contained in the data plane VCN 418. The service gateway 436 contained in the control plane VCN 416 and contained in the data plane VCN 418 can be communicatively couple to cloud services 456.

In some examples, the pattern illustrated by the architecture of block diagram 400 of FIG. 4 may be considered an exception to the pattern illustrated by the architecture of block diagram 300 of FIG. 3. The pattern illustrated by the architecture of block diagram 400 of FIG. 4 may be implemented for a customer of the IaaS provider if the IaaS provider cannot directly communicate with the customer (e.g., a disconnected region). The respective containers 467(1)-(N) that are contained in the VMs 466(1)-(N) for each customer can be accessed in real-time by the customer. The containers 467(1)-(N) may be configured to make calls to respective secondary VNICs 472(1)-(N) contained in app subnet(s) 426 of the data plane app tier 446 that can be contained in the container egress VCN 468. The secondary VNICs 472(1)-(N) can transmit the calls to the NAT gateway 438 that may transmit the calls to public Internet 454. In this example, the containers 467(1)-(N) that can be accessed in real-time by the customer can be isolated from the control plane VCN 416 and can be isolated from other entities contained in the data plane VCN 418. The containers 467(1)-(N) may also be isolated from resources from other customers.

In other examples, the customer can use the containers 467(1)-(N) to call cloud services 456. In this example, the customer may execute code in the containers 467(1)-(N) that requests a service from cloud services 456. The containers 467(1)-(N) can transmit this request to the secondary VNICs 472(1)-(N) that can transmit the request to the NAT gateway that can transmit the request to public Internet 454. Public Internet 454 can transmit the request to LB subnet(s) 422 contained in the control plane VCN 416 via the Internet gateway 434. In response to determining the request is valid, the LB subnet(s) can transmit the request to app subnet(s) 426 that can transmit the request to cloud services 456 via the service gateway 436.

It should be appreciated that IaaS architectures 100, 200, 300, 400 depicted in the figures may have other components than those depicted. Further, the embodiments shown in the figures are some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

In one or more embodiments, a computer network provides connectivity among a set of nodes. The nodes may be local to and/or remote from one another. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally, or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of one another. Network resources are dynamically assigned to the requests and/or clients on an on-demand basis. Network resources assigned to requests and/or clients may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications that are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from one another (also referred to as “tenants” or “customers”). The computer network and the network resources thereof are accessed by clients corresponding to different tenants. Such a computer network may be referred to as a “multi-tenant computer network.” Several tenants may use the same network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments in a multi-tenant computer network, tenant isolation is implemented to ensure that the applications and/or data of different tenants are not shared with each other. Various tenant isolation approaches may be used.

In an embodiment, tenants are associated with a tenant ID. Each network resource of the multi-tenant computer network is tagged with a tenant ID. A tenant is permitted access to a particular network resource if the tenant and the particular network resource is associated with the same tenant ID.

In an embodiment, each tenant is associated with a tenant ID. Each application, implemented by the computer network, is tagged with a tenant ID. Additionally, or alternatively, each data structure and/or dataset stored by the computer network is tagged with a tenant ID. A tenant is permitted access to a particular application, data structure, and/or dataset if the tenant and the particular application, data structure, and/or dataset are associated with the same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates the tenants that have authorization to access an application. For each application, a list of tenant IDs of tenants authorized to access the application is stored. A tenant is permitted access to a particular application if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network are transmitted to other devices within the same tenant overlay network. Encapsulation tunnels are used to prohibit any transmissions from a source device on a tenant overlay network to devices in other tenant overlay networks. Specifically, the packets received from the source device are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 4. Computer System

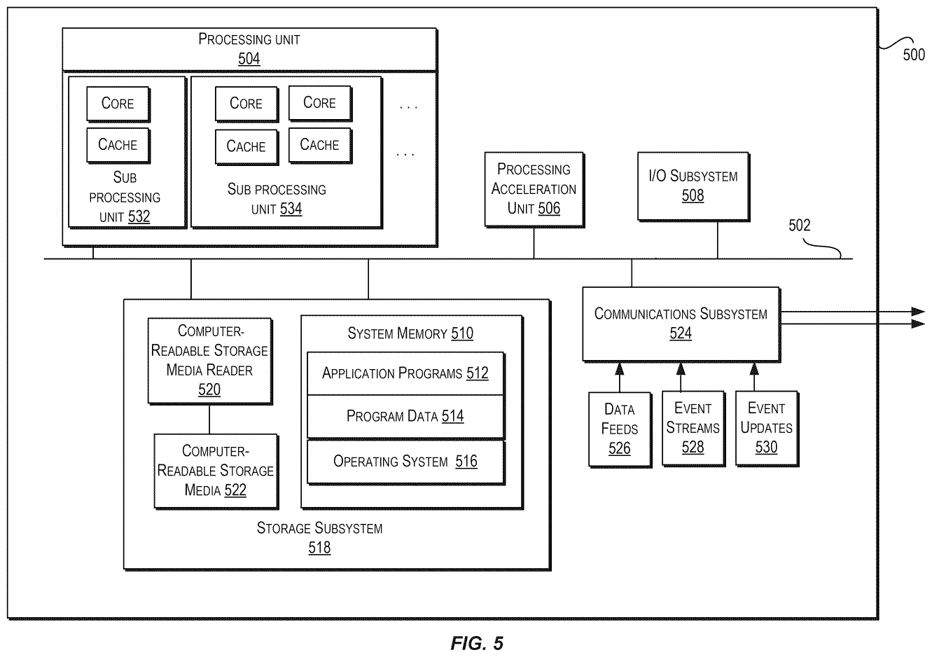

FIG. 5 illustrates an example computer system 500, where various embodiments may be implemented. The system 500 may be used to implement any of the computer systems described above. As shown in FIG. 5, computer system 500 includes a processing unit 504 that communicates with several peripheral subsystems via a bus subsystem 502. These peripheral subsystems may include a processing acceleration unit 506, an I/O subsystem 508, a storage subsystem 518, and a communications subsystem 524. Storage subsystem 518 includes tangible computer-readable storage media 522 and a system memory 510.

Bus subsystem 502 provides a mechanism for letting the various components and subsystems of computer system 500 communicate with each other as intended. Although bus subsystem 502 is shown schematically as a single bus, alternative embodiments of the bus subsystem may utilize multiple buses. Bus subsystem 502 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. The PCI bus can be implemented as a Mezzanine bus manufactured to the IEEE P1386.1 standard.

Processing unit 504 that can be implemented as one or more integrated circuits (e.g., a conventional microprocessor or microcontroller) controls the operation of computer system 500. One or more processors may be included in processing unit 504. These processors may include single core or multicore processors. In certain embodiments, processing unit 504 may be implemented as one or more independent processing units 532 and/or 534 with single or multicore processors included in each processing unit. In other embodiments, processing unit 504 may also be implemented as a quad-core processing unit formed by integrating two dual-core processors into a single chip.

In various embodiments, processing unit 504 can execute a variety of programs in response to program code and can maintain multiple concurrently executing programs or processes. At any given time, some of the program code to be executed can be resident in processing unit 504 and/or in storage subsystem 518. Through suitable programming, processing unit 504 can provide various functionalities described above. Computer system 500 may additionally include a processing acceleration unit 506 that can include a digital signal processor (DSP), a special-purpose processor, and/or the like.

I/O subsystem 508 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator) through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include various possible types of devices and mechanisms for outputting information from computer system 500 to a user or other computer. For example, user interface output devices may include, without limitation, a variety of display devices that visually convey text, graphics, and audio/video information such as monitors, printers, speakers, headphones, automotive navigation systems, plotters, voice output devices, and modems.

Computer system 500 may comprise a storage subsystem 518 that provides a tangible, non-transitory, computer-readable storage medium for storing software and data constructs that provide the functionality of the embodiments described in this disclosure. The software can include programs, code modules, instructions, scripts, etc., that when executed by one or more cores or processors of processing unit 504, provide the functionality described above. Storage subsystem 518 may also provide a repository for storing data used in accordance with the present disclosure.

As depicted in the example in FIG. 5, storage subsystem 518 can include various components including a system memory 510, computer-readable storage media 522, and a computer readable storage media reader 520. System memory 510 may store program instructions, such as application programs 512, that are loadable and executable by processing unit 504. System memory 510 may also store data, such as program data 514, that is used during the execution of the instructions and/or data that is generated during the execution of the program instructions. Various different kinds of programs may be loaded into system memory 510 including but not limited to client applications, Web browsers, mid-tier applications, relational database management systems (RDBMS), virtual machines, containers, etc.

System memory 510 may also store an operating system 516. Examples of operating system 516 may include various versions of Microsoft Windows®, Apple Macintosh®, and/or Linux operating systems, a variety of commercially available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations, where computer system 500 executes one or more virtual machines, the virtual machines along with their guest operating systems (GOSs) may be loaded into system memory 510 and executed by one or more processors or cores of processing unit 504.

System memory 510 can come in different configurations depending upon the type of computer system 500. For example, system memory 510 may be volatile memory (such as random access memory (RAM)) and/or non-volatile memory (such as read-only memory (ROM), flash memory, etc.). Different types of RAM configurations may be provided including a static random access memory (SRAM), a dynamic random access memory (DRAM), and others. In some implementations, system memory 510 may include a basic input/output system (BIOS) containing basic routines that help to transfer information between elements within computer system 500 such as during start-up.

Computer-readable storage media 522 may represent remote, local, fixed, and/or removable storage devices plus storage media for temporarily and/or more permanently containing, storing, computer-readable information for use by computer system 500 including instructions executable by processing unit 504 of computer system 500.

Computer-readable storage media 522 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 522 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 522 may include, but is not limited to, Zip® drives, flash memory cards, universal serial bus (USB) flash drives, secure digital (SD) cards, DVD disks, digital video tape, and the like. Computer-readable storage media 522 may also include solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 500.

Machine-readable instructions executable by one or more processors or cores of processing unit 504 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 524 provides an interface to other computer systems and networks. Communications subsystem 524 serves as an interface for receiving data from and transmitting data to other systems from computer system 500. For example, communications subsystem 524 may enable computer system 500 to connect to one or more devices via the Internet. In some embodiments, communications subsystem 524 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments, communications subsystem 524 can provide wired network connectivity (e.g., Ethernet) in addition to or instead of a wireless interface.

In some embodiments, communications subsystem 524 may also receive input communication in the form of structured and/or unstructured data feeds 526, event streams 528, event updates 530, and the like on behalf of one or more users who may use computer system 500.

By way of example, communications subsystem 524 may be configured to receive data feeds 526 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 524 may also be configured to receive data in the form of continuous data streams that may include event streams 528 of real-time events and/or event updates 530 that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 524 may also be configured to output the structured and/or unstructured data feeds 526, event streams 528, event updates 530, and the like to one or more databases that may be in communication with one or more streaming data source computers coupled to computer system 500.

Computer system 500 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 500 depicted in FIG. 5 is intended as an example and should not be construed to limit the scope of any of the claims. Many other configurations having more or fewer components than the system depicted in FIG. 5 are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

### 4. Cloud Network Configuration System

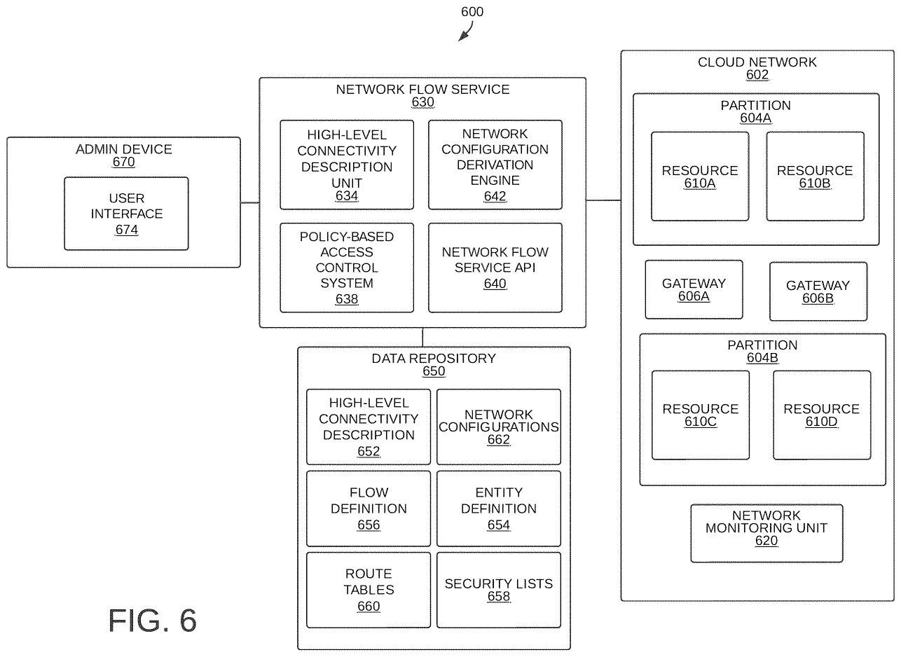

FIG. 6 illustrates a system for configuring a cloud network in accordance with one or more embodiments. As illustrated in FIG. 6, system 600 includes cloud network 602, partitions 604A and 604B, gateways 606A and 606B, resources 610A, 610B, 610C, and 610D, network monitoring unit 620, network flow service 630, high-level connectivity description unit 634, policy-based access control system 638, network flow service API 640, network configuration derivation engine 642, data repository 650, high-level connectivity descriptions 652, entity definitions 654, flow definitions 656, security lists 658, route tables 660, network configurations 662, admin device 670, and a user interface 674.

In one or more embodiments, system 600 may include more or fewer components than the components illustrated in FIG. 6. The components illustrated in FIG. 6 may be local to or remote from the others. The components illustrated in FIG. 6 may be implemented in software and/or hardware. Components may be distributed over multiple applications and/or machines. Multiple components may be combined into one application and/or machine. Operations described with respect to one component may instead be performed by another component.

In an embodiment, cloud network 602 encompasses multiple partitions and resources managed by a network flow service. Cloud network 602 provides a virtualized environment for deploying and interconnecting various computing resources. Partitions 604A and 604B within cloud network 602 serve as logical boundaries for organizing and isolating resources.

In an embodiment, gateways 606A and 606B facilitate communication between different network segments or external networks. Gateways 606A and 606B handle routing and traffic management, enabling secure and controlled data flow across network boundaries. Network flow service 630 dynamically configures routes through these gateways based on high-level connectivity requirements and security policies.

In an embodiment, resources 610A, 610B, 610C, and 610D represent various computing entities within the cloud network. Resources 610A-D include virtual machines, containers, storage volumes, or other cloud-based services. These resources form the building blocks of applications and services deployed in the cloud environment. Network flow service 630 manages connectivity between these resources, establishing proper communication paths while maintaining security boundaries.

In an embodiment, network monitoring unit 620 observes the state and behavior of the cloud network. Network monitoring unit 620 detects changes in resources, traffic patterns, and network conditions. Information gathered by network monitoring unit 620 feeds into the network flow service for dynamic reconfiguration and optimization. The monitoring unit tracks resource creation, deletion, and modification events as well as network performance metrics and security-related incidents. This real-time monitoring enables the network flow service to respond quickly to changes and maintain an accurate representation of the network state.

In an embodiment, network flow service 630 manages and orchestrates network connectivity within the cloud environment. Network flow service 630 translates high-level connectivity descriptions into concrete network configurations. Components of network flow service 630 work together to maintain consistency between user-defined intents and the actual network state. Network flow service 630 continuously reconciles the desired state expressed in high-level descriptions with the current state of the network, automatically adjusting configurations as needed. This approach allows for a declarative model of network management, where users specify what they want rather than how to achieve it.

In an embodiment, high-level connectivity description unit 634 within network flow service 630 processes user-defined connectivity requirements. High-level connectivity description unit 634 interprets abstract descriptions of desired network relationships. High-level connectivity description unit 634 parses high level user inputs and translates these abstract concepts into a standardized internal representation used by network configuration derivation engine 642.

In an embodiment, network configuration derivation engine 642 translates high-level connectivity descriptions into specific network settings. Network configuration derivation engine 642 generates security and route rule configuration based on the abstract descriptions provided by users. This engine bridges the gap between user intent and technical implementation. Network configuration derivation engine 642 interprets high-level concepts and translates them into specific firewall rules, subnet configurations, and routing entries. Network configuration derivation engine 642 considers factors like network topology, existing configurations, and security best practices during the translation process. Network configuration derivation engine 642 also reviews the generated configurations for performance and security, minimizing unnecessary rules and potential conflicts.

In an embodiment, policy-based access control system 638 enforces permissions and restrictions on network configuration actions. The system evaluates user roles and organizational policies to determine allowed operations, ensuring that changes to network settings are restricted to authorized personnel. Policy-based access control system 638 extends beyond simple role-based access control, incorporating aliases and group-based policies within partitions, so groups can make resources available to other groups with potentially restricted functionality using the aliases. An alias is a representation or proxy of an entity instance that exists in one partition and made available for use in another partition. Aliases allow for controlled access to resources across partition boundaries.

In an embodiment, network flow service API 640 provides an interface for users and other systems to interact with the network flow service. Network flow service API 640 accepts requests for configuration changes, queries current network states, and returns results of network operations. Network flow service API 640 serves as the primary point of programmatic access to the network flow service's capabilities. Network flow service API 640 supports both synchronous and asynchronous operations. Network flow service API 640 handles create, read, update, and delete (CRUD) operations for network flow service resources, processing synchronous operations immediately and queueing asynchronous tasks into a request queue. In one embodiment, a flow manager watches the request queue and creates processing jobs.

In one or more embodiments, data repository 650 is any type of storage unit and/or device (e.g., a file system, database, collection of tables, or any other storage mechanism) for storing data. Furthermore, data repository 650 may include multiple different storage units and/or devices. The multiple different storage units and/or devices may or may not be of the same type or located at the same physical site. Furthermore, data repository 650 may be implemented or executed on the same computing system as network flow service 630. Additionally, or alternatively, data repository 650 may be implemented or executed on a computing system separate from network flow service 630. Data repository 650 may be communicatively coupled to network flow service 630 via a direct connection or via a network.

In an embodiment, data repository 650 stores various data elements used by the network flow service. Data repository 650 includes high-level connectivity descriptions 652, entity definitions 654, and flow definitions 656. These stored elements form the basis for deriving and maintaining network configurations. High-level connectivity descriptions 652 capture user intents in a structured format. Entity definitions 654 define the characteristics and attributes of network resources. Flow definitions 656 specify patterns of allowed communication between entities, including protocols, ports, and directionality. In one example, data repository 650 is a key-value store, such as an eted cluster, that stores resource definitions as key-value pairs.

In an embodiment, data repository 650 also stores derived network configurations, including security lists 658 and route tables 660. Security lists 658 and route tables 660 represent the concrete implementation of network policies and routing decisions. Network flow service 630 applies these configurations to the relevant resources in cloud network 602. Security lists 658 include detailed firewall rules, specifying allowed ingress and egress traffic for the network interface. Route tables 660 define the paths for network traffic, determining how data packets are forwarded between subnets, to internet gateways, or to other network services. The repository maintains consistency between these low-level configurations and the high-level descriptions, automatically updating derived configurations when high-level intents change.

In an embodiment, admin device 670 provides administrative access to the network flow service and cloud network. Admin device 670 allows authorized personnel to manage policies, monitor network status, and perform high-level configuration tasks. Admin device 670 allows users to oversee the entire network management process. Admin device 670 supports secure remote access, enabling administrators to manage network configurations from anywhere. Admin device 670 integrates with policy-based access control system 638 to enforce role-based permissions, ensuring that administrators are restricted to perform actions within their authorized scope. Admin device 670 also provides real-time alerts and notifications about network events or configuration changes that require attention.

In an embodiment, user interface 674 on admin device 670 presents network information and configuration options to administrators. User interface 674 offers controls for defining high-level connectivity descriptions, viewing network states, and initiating configuration changes. User interface 674 simplifies complex network management tasks for administrators. User interface 674 provides visual representations of network topologies, allowing administrators to easily understand and manipulate connectivity relationships.

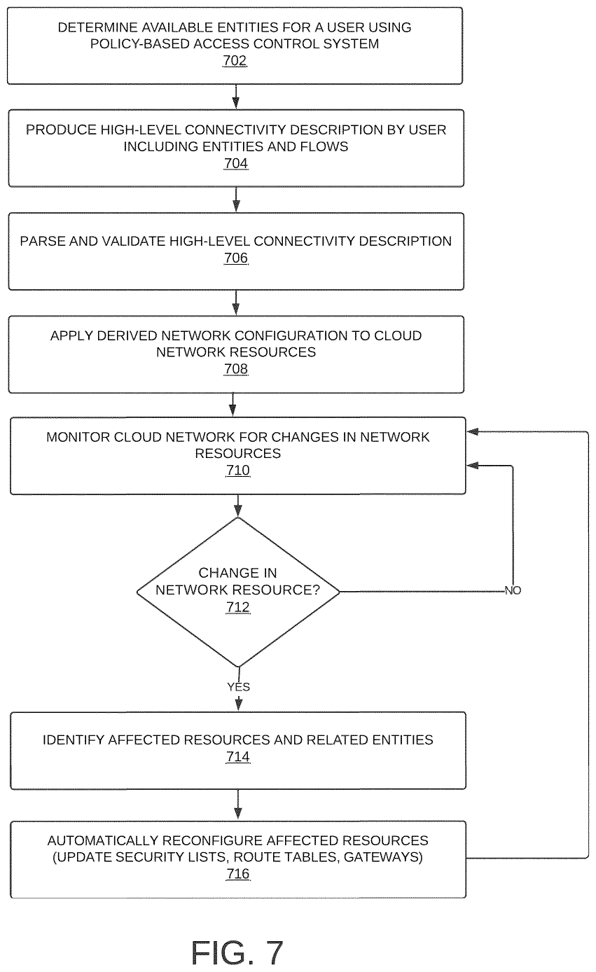

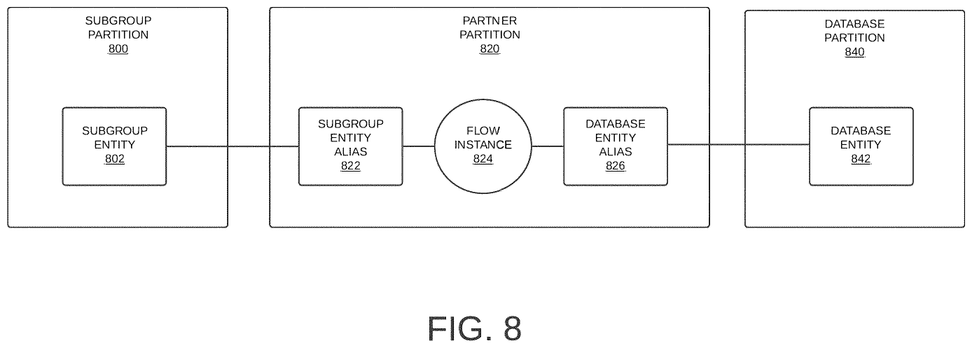

In one or more embodiments, cloud network 602, partitions 604A and 604B, gateways 606A and 606B, resources 610A, 610B, 610C, and 610D, network monitoring unit 120, a network flow service 630, high-level connectivity description unit 634, policy-based access control system 638, network flow service API 640, network configuration derivation engine 642, data repository 650, admin device 670, and user interface 674 refer to hardware and/or software configured to perform operations described herein for cloud network configuration. Examples of operations for cloud network configuration are described below with reference to FIGS. 7 and 8.

In accordance with an embodiment, cloud network 602, partitions 604A and 604B, gateways 606A and 606B, resources 610A, 610B, 610C, and 610D, network monitoring unit 120, a network flow service 630, high-level connectivity description unit 634, policy-based access control system 638, network flow service API 640, network configuration derivation engine 642, data repository 650, admin device 670, and user interface 674 are implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

### 5. Cloud Network Configuration Method

FIG. 7 illustrates an example set of operations for configuring a cloud network in accordance with one or more embodiments. One or more operations illustrated in FIG. 7 may be modified, rearranged, or omitted. Accordingly, the particular sequence of operations illustrated in FIG. 7 should not be construed as limiting the scope of one or more embodiments.

In an embodiment, the system abstracts network configuration details within cloud environments. The system allows users to describe connectivity using high-level objects, eliminating the need for direct manipulation of security list rules and route table rules. The system propagates changes throughout the environment when resources are modified. The system enables multiple teams to control their portion of the network and connect to other teams' resources without manual coordination. Policy-based access governance enforces restrictions on network connectivity configurations. When the system detects a change, the system automatically reconfigures related resources. The system results in casier governance in compliance-restricted environments, delegated management of network space shared by multiple teams, and reduced need for networking expertise on application teams.

In an embodiment, the system eliminates the need for extensive networking expertise among application teams, simplifying the process of network configuration. By automating both sides of network connections, the system reduces friction between teams when deploying new infrastructure or onboarding customers. The system allows organizations to establish multiple instances of approved connectivity patterns without requiring individual review for instances, streamlining the implementation of security-compliant network configurations.

In an embodiment, the system implements a declarative approach to network management. Users describe their desired connectivity using entities that represent groups of endpoints and flows that define connections between entities. The system derives the underlying network configuration from these high-level objects, translating abstract descriptions into concrete security and routing rules. When changes occur to related resources, the system automatically reprocesses configurations to maintain consistency with the high-level descriptions.

In an embodiment, the system supports various endpoint types to accommodate different network scenarios. These include subnets, remote resources, external resources, and different gateway types, such as service gateways, NAT gateways, and internal gateways. The system automatically selects appropriate routing paths based on the defined high-level connectivity requirements and the characteristics of the endpoints involved.

In an embodiment, the system employs a hierarchical policy model to manage access control and permissions. Administrators define organization-wide rules at a high level that are then refined for specific teams or projects. The system supports role-based and attribute-based access control, integrating with enterprise identity management systems to enforce fine-grained permissions across different user groups and roles.

In an embodiment, the system determines available entities for a user utilizing a policy-based access control system (Operation 702). The system enforces access restrictions and permissions, ensuring users interact with authorized network resources and configurations. Based on the access control policies, the system presents a subset of available entities to the user through an interface.

In an embodiment, the system uses a policy-based access control mechanism to govern network connectivity configurations. Administrators define policies allowing fine-grained control over resource creation and modification permissions.

In an embodiment, the system facilitates the production of a high-level connectivity description by the user, encompassing entities and flows (Operation 704). Users define desired network connections using abstract concepts rather than low-level configuration details. The high-level description captures the logical structure of network relationships between various resources and services.

In an embodiment, the system allows users to describe connectivity using high-level objects rather than directly configuring security list rules and route table rules. The system automates network configuration to propagate changes throughout the environment when resources are modified. The system allows multiple teams to control their portion of the network and connect to other teams' resources without manual coordination. Policy-based access governance enforces restrictions on what network connectivity users configure. Users declaratively describe connectivity using entities (groups of endpoints) and flows (connectivity between entities). The system derives underlying network configuration from these objects. Related resources automatically reprocess when changes occur. For example, if two entities are selected by a common flow in different roles, modifying one entity triggers reconfiguration of both entities to maintain correct connectivity. Users define connectivity patterns via flow definitions and entity definitions then instantiate resources based on granted policy permissions.

In an embodiment, entity definitions specify resource types and compatible endpoint types. Entity instances include endpoints and labels within a partition. Flow definitions describe connections between entity types, including ports, protocols, and statefulness. Flow instances select entities to connect based on labels or other criteria. The system supports various endpoint types like subnets, remote resources, external resources, and different gateway types.

In an embodiment, the system parses and validates the high-level connectivity description provided by the user (Operation 706). The system analyzes the user-defined entities and flows, checking for consistency and adherence to established policies. Validation ensures the proposed network configuration aligns with security requirements and other constraints.

In an embodiment, the system implements a validation process prior to deriving network configurations from high-level connectivity descriptions. Upon receiving a high-level connectivity description, the system first identifies the source of the description, which may be a user, an application, or an automated process. The system then retrieves the permissions associated with this source from its access control database. These permissions define the scope of network configurations the source is authorized to establish within the cloud network environment. The system proceeds to analyze elements of the high-level connectivity description against the retrieved permissions, verifying that proposed entities, flows, and their attributes fall within the authorized parameters. This validation step ensures that the source cannot inadvertently or intentionally create network configurations that exceed their privileges or violate organizational security policies.

In an embodiment, the system applies the derived network configuration to cloud network resources (Operation 708). The system translates the high-level description into specific, actionable network settings. Security lists, route tables, and gateway configurations receive updates based on the validated connectivity description.

In an embodiment, the system implements a deterministic process to derive network configurations from high-level descriptions. When processing entity instances, the system identifies endpoints to determine source and destination Classless Inter-Domain Routing (CIDRs). The system analyses flow instances and selects the entity instance to derive port configurations and directionality based on the entity's role as client or server. Related entity instances selected in opposite roles have their endpoints examined to establish complete connectivity paths.

In an embodiment, the system uses endpoint types, like subnets, remote resources, and various gateways, to determine routing rules necessary for connections. The system applies derived security and routing rules to the processed entity instances. This automated approach eliminates manual configuration of individual rules, reducing human error and inconsistencies. In an embodiment, the system uses various gateway types. Internet gateways enable resources in public subnets to access the public internet. Service gateways facilitate connections to cloud provider-specific services. Network Address Translation (NAT) gateways allow private subnet resources to initiate outbound connections. The system evaluates these gateways based on a set of predefined criteria, such as gateway type, virtual cloud network or partition, current load, bandwidth capacity, and other relevant factors. This evaluation enables the system to optimize network performance and efficiency. After selecting the most suitable gateway, the system automatically configures it to establish the necessary connections between the entities in the flow. The system prioritizes the use of peering gateways over dynamic routing gateways when both options are available. This preference stems from the typically lower latency and more predictable routing paths offered by peering connections. For cross-region connectivity within the cloud provider, the system leverages dynamic routing gateways instead of local peering gateways. The system determines routing paths based on resource locations and available connectivity options. This abstraction shields users from the complexities of inter-region networking configuration.

In an embodiment, the system continuously monitors the cloud network for changes in network resources (Operation 710). The system maintains awareness of the dynamic nature of cloud environments, tracking modifications to existing resources and the introduction of new components. This ongoing monitoring enables rapid response to network alterations.

In an embodiment, the system checks if there is a change in network resources (Operation 712). The check may be done by checking for API requests or by monitoring the network. Upon identifying a modification, the system evaluates the impact on existing network configurations. The change detection mechanism triggers subsequent steps to maintain consistency between the high-level description and actual network state. If NO in operation 712, then the system returns to operation 710. If YES in operation 712, then the system proceeds to operation 714.

In an embodiment, the system evaluates related entities and flows to determine necessary reconfigurations. Processing an entity instance involves identifying attached endpoints, relevant flow instances, and related entities as well as deriving appropriate security and routing rules.

In an embodiment, API invocations trigger cascading evaluations and updates. Modifying an entity instance prompts examination of related resources in the same partition selected by common flow instances in opposite roles. Flow instance modifications re-evaluate entity instances in the partition against selection criteria, queueing affected resources for processing.

In an embodiment, if a change is detected, the system identifies affected resources and related entities following a detected change (Operation 714). The system analyzes the dependencies and connections defined in the high-level connectivity description and determines resources impacted by the change.

In an embodiment, the system automatically reconfigures affected resources to maintain consistency with the high-level connectivity description (Operation 716). The system updates security lists, route tables, and gateway configurations, as necessary. Automated reconfiguration ensures the network state remains aligned with the high-level connectivity description. After reconfiguring affected resources in operation 716 or if no change is detected in operation 714, the system returns to monitoring the cloud network in operation 710.

In an embodiment, the system-derived network configuration includes multiple configuration types, such as security lists, route tables, and gateway configurations. The system identifies the configuration types associated with the resources then reconfigures the multiple configuration types.

In an embodiment, upon detecting the addition of a new subnet to a first resource, the system initiates a series of automated actions to maintain network consistency. The system first determines the associations between the first resource and other resources in the network environment. For a second resource associated with the first resource, the system updates the security list rules to accommodate traffic from the newly added subnet. This update ensures that the second resource can receive communications originating from the new subnet, maintaining intended connectivity. The system modifies the route table at the second resource, adding the necessary routes to enable bi-directional communication with the new subnet. These automated adjustments ensure that network paths remain valid and secure following infrastructure changes, eliminating the need for manual reconfiguration and reducing the risk of connectivity issues or security gaps.

In an embodiment, when the system detects the creation of a new entity instance bearing a label that matches an entity defined in the high-level connectivity description, the system triggers an automated reconfiguration process. The system generates a modified system-derived network configuration that incorporates the new entity instance into the existing network topology. This modified configuration includes updated security list rules that permit traffic to and from the new entity instance as well as revised route table entries that establish proper network paths. The system applies these configuration changes to both the new entity instance and the relevant second resource. By implementing these bidirectional security and routing rules, the system ensures seamless communication between the newly added entity instance and the existing second resource. This automated approach maintains consistency between the high-level connectivity description and the actual network state, eliminating manual intervention and reducing the potential for configuration errors.

### 6. Cloud Network Example

FIG. 8 illustrates an example cloud network arrangement in accordance with one or more embodiments. The system comprises subgroup partition 800, partner partition 820, and database partition 840.

In an embodiment, subgroup partition 800 includes subgroup entity 802. Subgroup partition 800 represents a team or group responsible for managing subnet groups or node groups within a network infrastructure. Partner partition 820, for example an application partition, includes subgroup entity alias 822, flow instance 824, and database entity alias 826. Partner partition 820 represents an application team or partner organization utilizing network resources. Database partition 840 includes database entity 842. Database partition 840 represents a team or group responsible for managing database resources within the network infrastructure.

In an embodiment, the partitions are a mechanism for isolating different elements for different teams. The entity instances, such as subgroup entity 802 and database entity 842, exist in a partition and are selectable by the flow instances in the same partition. Flow instance selectors use labels applied to entity instances to determine the entity instances that participate in a flow.

In an embodiment, aliases enable the owner of an entity instance to share that resource with another partition. This allows the database team, for example, to establish the connectivity they need to operate database entity 842 in their partition and then grant access to an application team by creating database entity alias 826 in the application team partition, partner partition 820. Similarly, subgroup entity 802 from subgroup partition 800 is represented by subgroup entity alias 822 in partner partition 820.

In an embodiment, the system uses partitions as logical boundaries to separate resources, functioning similarly to Kubernetes namespaces or cloud provider compartments. Default flows define baseline connectivity applied universally to managed resources. Given provider constraints, the system replicates shared security lists across virtual networks to ensure applicability in the subnets.

In an embodiment, the system employs containerization and Kubernetes for deployment flexibility and scalability. Components execute as separate deployments or stateful sets within Kubernetes clusters.

Subgroup entity alias 822 in partner partition 820 corresponds to subgroup entity 802 in subgroup partition 800. This alias relationship enables the sharing of subgroup entity 802 with the partner partition 820, allowing the application team to access and utilize resources managed by the subnet group team. Similarly, database entity alias 826 in the partner partition 820 corresponds to database entity 842 in database partition 840. This alias relationship enables the sharing of database entity 842 with partner partition 820, allowing the application team to access and utilize database resources.

In an embodiment, flow instances, such as flow instance 824, select entity instances based on the type of entity defined by the parent flow definition in the ‘consumer’ (client) or ‘provider’ (server) role. Flow instances select entities based on selectors, such as resource selectors, that identify a specific entity instance to select, or label, selectors. If an entity instance is the ‘type’ defined for consumer and the entity instance has the labels defined by label selectors (or is identified by a resource selector), then the flow instance ‘selects’ the entity instance for that ‘role’.

In an embodiment, a flow definition establishes the framework for network connectivity by specifying the types of entities that participate in a particular communication pattern. The system utilizes the concept of ‘consumer’ and ‘provider’ roles within the flow definition, allowing for clear delineation of data flow directionality. These roles correspond to client and server entities respectively, providing a logical structure for defining network interactions.

In an embodiment, the system implements flow instances based on predefined flow definitions. Flow instances inherit characteristics from its parent definition, such as the ‘exampleFlow’ type, while allowing for specific customization within the constraints of the definition. The system uses these flow instances to create concrete representations of desired network connections within the cloud environment.

In an embodiment, the system categorizes network entities into distinct types, primarily focusing on consumer (client) and provider (server) roles. These entity types serve as templates for creating specific entity instances that represent actual resources within the network. The system maintains a clear separation between the abstract entity types and their concrete implementations as entity instances.

In an embodiment, the system associates subnet-type endpoints with entity instances to define their network presence. These endpoints correspond to actual subnets within the underlying cloud infrastructure, providing a bridge between the high-level network flow service abstractions and the physical network topology.

In an embodiment, the system derives security list rules from the flow instances and their associated entity instances. The system applies security list rules to the appropriate cloud provider subnets, effectively implementing the desired network policies and access controls. The system ensures that the low-level security configurations accurately reflect the high-level connectivity intentions expressed through the network flow service.

In an embodiment, the system extends its configuration derivation beyond security lists to include routing rules. The system generates and applies routing configurations in a manner similar to security list rules, ensuring that network traffic is directed according to the specified flow definitions and entity relationships.

### 7. Practical Applications, Advantages & Improvements

The network flow service system provides significant advantages in managing complex cloud network environments. By abstracting network configuration details into high-level connectivity descriptions, the system enables users without deep networking expertise to define and manage sophisticated network topologies. Automated derivation of network configurations from these high-level descriptions reduces manual errors and ensures consistency across large-scale deployments. The system's ability to detect and respond to resource changes in real-time improves network resilience and adaptability, crucial in dynamic cloud environments. Policy-based access control integrated into the configuration process enhances security and compliance, allowing organizations to enforce strict governance over network changes. The system's automated reconfiguration capabilities minimize downtime and reduce the operational burden on IT teams, enabling faster deployment of new applications and services.

### 8. Miscellaneous; Extensions

Unless otherwise defined, terms (including technical and scientific terms) are to be given their ordinary and customary meaning to a person of ordinary skill in the art and are not to be limited to a special or customized meaning unless expressly so defined herein.

This application may include references to certain trademarks. Although the use of trademarks is permissible in patent applications, the proprietary nature of the marks should be respected and efforts made to prevent their use in any manner that might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions, that when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application in the specific form in which such claims issue, including any subsequent correction.

What is claimed is:

1. A non-transitory computer readable medium comprising instructions which, when executed by one or more hardware processors, causes performance of operations comprising:
receiving a high-level connectivity description comprising a plurality of entities and a plurality of flows that each represent connectivity between two or more entities in the plurality of entities;
based on the high-level connectivity description: deriving, by a system-executed process, a system-derived network configuration;
applying the system-derived network configuration to configure a plurality of resources, corresponding to the plurality of entities, in a cloud network environment;
after a modification, addition, or removal of a first resource in the cloud network environment, modifying the system-derived network configuration to (a) maintain consistency with the high-level connectivity description and (b) account for the modification, addition, or removal the first resource in the cloud network environment, wherein modifying the system-derived network configuration results in a generation of a modified system-derived network configuration; and
applying the modified system-derived network configuration to at least a second resource in the cloud network environment.

2. The non-transitory media of claim 1, wherein modifying the system-derived network configuration to (a) maintain consistency with the high-level connectivity description and (b) account for the modification, addition, or removal the first resource in the cloud network environment comprises:
identifying an addition of a new subnet to the first resource;
determining that the second resource is associated with the first resource;
updating a security list rule at the second resource to allow traffic from the new subnet; and
modifying a route table at the second resource to include routes to the new subnet.

3. The non-transitory media of claim 1, wherein modifying the system-derived network configuration to (a) maintain consistency with the high-level connectivity description and (b) account for the modification, addition, or removal the first resource in the cloud network environment comprises:
identifying an addition of a new entity instance with a label matching an entity in the high-level connectivity description, wherein the modified system-derived network configuration includes security list rules and route table entries to enable connectivity between the new entity instance and the second resource, and wherein applying the modified system-derived network configuration facilitates bidirectional communication between the second resource and the new entity instance.

4. The non-transitory media of claim 3, wherein the operations further comprise updating a gateway to accommodate traffic to the new entity instance.

5. The non-transitory media of claim 1, wherein the operations further comprise:
before deriving the system-derived network configuration, checking for permission to configure the entities and the flows using a policy-based access control system.

6. The non-transitory media of claim 5, wherein groups are used by the policy-based access control system to determine permissions to configure the entities and the flows.

7. The non-transitory media of claim 6, wherein the high-level connectivity description includes flow definitions and entity definitions wherein the operations further comprise:
presenting an interface for selecting a plurality of connectivity patterns corresponding to the plurality of entities, the plurality of connectivity patterns being allowed by the policy-based access control system; and
receiving user input comprising a connectivity pattern of the plurality of connectivity patterns, wherein the system-derived network configuration is based at least in part on the connectivity pattern.

8. The non-transitory media of claim 1, wherein the operations further comprise, before deriving the system-derived network configuration, validating the high-level connectivity description against permissions associated with a source of the high-level connectivity description to determine that the source is authorized for establishing a network in the cloud network environment in accordance with the high-level connectivity description.

9. The non-transitory media of claim 1, wherein the operations further comprise:
identifying multiple available gateways for connecting entities in a flow;
selecting a gateway from the multiple available gateways based on at least a gateway type; and
configuring the selected gateway to connect the entities in the flow.

10. The non-transitory media of claim 9, wherein selecting a gateway from the multiple available gateways includes selecting a peering gateway of the multiple available gateways rather than a dynamic routing gateway of the multiple available gateways and wherein configuring the selected gateway includes configuring the peering gateway.

11. The non-transitory media of claim 1, wherein the operations further comprise:
associating an entity with a label by a first group; and
making the label available for use by a second group, wherein the high-level connectivity description uses the label.

12. The non-transitory media of claim 1, wherein the system-derived network configuration includes port numbers, security lists and route rules for the plurality of resources.

13. The non-transitory media of claim 1, wherein the system-executed process comprises a deterministic process.

14. The non-transitory media of claim 1, wherein a first group associates an entity with an alias, further comprising using the entity by a second group, wherein the high-level connectivity description references the alias.

15. A method comprising:
receiving a high-level connectivity description comprising a plurality of entities and a plurality of flows that each represent connectivity between two or more entities in the plurality of entities;
based on the high-level connectivity description: deriving, by a system-executed process, a system-derived network configuration;
applying the system-derived network configuration to configure a plurality of resources, corresponding to the plurality of entities, in a cloud network environment;
after a modification, addition, or removal of a first resource in the cloud network environment, modifying the system-derived network configuration to (a) maintain consistency with the high-level connectivity description and (b) account for the modification, addition, or removal the first resource in the cloud network environment, wherein modifying the system-derived network configuration results in a generation of a modified system-derived network configuration; and
applying the modified system-derived network configuration to at least a second resource in the cloud network environment, wherein the method is performed by at least one device including a hardware processor.

16. The method of claim 15, wherein modifying the system-derived network configuration to (a) maintain consistency with the high-level connectivity description and (b) account for the modification, addition, or removal the first resource in the cloud network environment comprises:
identifying an addition of a new subnet to the first resource;
determining that the second resource is associated with the first resource;
updating a security list rule at the second resource to allow traffic from the new subnet; and
modifying a route table at the second resource to include routes to the new subnet.

17. The method of claim 15, wherein modifying the system-derived network configuration to (a) maintain consistency with the high-level connectivity description and (b) account for the modification, addition, or removal the first resource in the cloud network environment comprises: identifying an addition of a new entity instance with a label matching an entity in the high-level connectivity description, wherein the modified system-derived network configuration includes security list rules and route table entries to enable connectivity between the new entity instance and the second resource, and wherein applying the modified system-derived network configuration facilitates bidirectional communication between the second resource and the new entity instance.

18. A system comprising:
at least one device including a hardware processor;
the system being configured to perform operations comprising:
receiving a high-level connectivity description comprising a plurality of entities and a plurality of flows that each represent connectivity between two or more entities in the plurality of entities;
based on the high-level connectivity description: deriving, by a system-executed process, a system-derived network configuration;
applying the system-derived network configuration to configure a plurality of resources, corresponding to the plurality of entities, in a cloud network environment;
after a modification, addition, or removal of a first resource in the cloud network environment, modifying the system-derived network configuration to (a) maintain consistency with the high-level connectivity description and (b) account for the modification, addition, or removal the first resource in the cloud network environment, wherein modifying the system-derived network configuration results in a generation of a modified system-derived network configuration; and
applying the modified system-derived network configuration to at least a second resource in the cloud network environment.

19. The system of claim 18, wherein modifying the system-derived network configuration to (a) maintain consistency with the high-level connectivity description and (b) account for the modification, addition, or removal the first resource in the cloud network environment comprises:
identifying an addition of a new subnet to the first resource;
determining that the second resource is associated with the first resource;
updating a security list rule at the second resource to allow traffic from the new subnet; and
modifying a route table at the second resource to include routes to the new subnet.

20. The system of claim 18, wherein modifying the system-derived network configuration to (a) maintain consistency with the high-level connectivity description and (b) account for the modification, addition, or removal the first resource in the cloud network environment comprises identifying an addition of a new entity instance with a label matching an entity in the high-level connectivity description, wherein the modified system-derived network configuration includes security list rules and route table entries to enable connectivity between the new entity instance and the second resource, and wherein applying the modified system-derived network configuration facilitates bidirectional communication between the second resource and the new entity instance.
